(19) United States
(12) Patent Application Publication
(10) Pub. No.: US 2004/0162803 A1
(43) Pub. Date: Aug. 19, 2004

(54) Method and system to enable a single sports software application's use across multiple sports

(76) Inventor: Jeffrey S. Rhoads, Sewickley, PA (US)

Correspondence Address: Jeffrey S. Rhoads, 330 Elizabeth St., Sewickley, PA, 15143-1425, US

(21) Appl. No.: 10/368,913

(22) Filed: Feb. 15, 2003

(51) Int. Cl. G06F 17/30

(52) U.S. Cl. 707/1

(57) ABSTRACT

A computer method and system that permits a single personal computer sports software application program and its related user interface to store, display, organize, analyze, output and otherwise manage information specific to any one of a number of different sports. Sports data is maintained within a sports season data entity (i.e., Season) that is comprised of, or references, games or similar season events and related information including game scores, rosters, player statistics, game notes, pictures and multimedia. Seasons are implemented in a modular form that enables the program to dynamically load the season's sports data. Seasons also reference independent sport packages that contain statistic definitions or other information specific to a given sport. Using the information contained within the Season and associated sport package, the program reconfigures its user interface, displayed data, output, and other properties where necessary to accommodate any sport specific requirements.

### CROSS-REFFERENCE TO RELATED APPLICATIONS

Not applicable

### BACKGROUND

1. Field of the Invention

The present invention relates to personal computer software used in either the home or educational institutions, and in particular to a method and system that enables a single sports software application program to modify its user interface and functional components to manage information specific to any one of a number of different sports.

2. Description of Prior Art

The extensive interest in sports within our society has produced numerous systems to augment or improve an athlete's performance, provide coaches with a more effective means to teach and organize, and to enable the athlete or fan to better observe, track and otherwise enjoy the sport of their choice. In the area of personal computer software, applications exist for almost any given sport to compile statistics and organize information related to a player or team. Other personal computer software applications enable an athlete to plan and monitor his training regimen along with recording information for actual performances. Sports simulations, including today's popular games, are available for most major sports.

A shared trait of these application programs is that their design is either specific to a single sport or limited in scope such that the application programs can only process sports information that is common to the multiple sports supported.

Sport specific design is most evident in the area of statistical applications where the data tracked and processed is necessarily related to a single sport. An application that tracks statistics for the sport of Basketball will include information on Rebounds, Free Throws, and 3-Point Field Goals. These statistics are generally applicable only to the sport of Basketball. Similarly, a software application program that tracks Volleyball statistics will most likely include Sets and Kills—two statistics specific to the sport of Volleyball. In those cases where an application developer decides to support multiple sports, separate sport specific versions of their software are created. Although each version may share a common theme, comparable feature sets, and a similar interface, they are designed in a manner where the application program's logic, presentation, and data structures are combined in a monolithic program dedicated to a specific sport. These distinct versions are usually marketed and sold as separate products. Although separate product versions may be desirable in some market related instances, the effort to create, maintain and support a different version of the program for each potential sport is extensive and can incur substantial additional development cost. From the perspective of a user interested in multiple sports, this approach usually results in increased purchase costs and the undesirable possibility of having to learn an additional user interface.

Current personal computer software application programs in the areas of sports games and simulation also exemplify sport specific design. Each game application program includes logic and supporting graphical information (i.e., the sports playing field, player uniforms, etc.) that is applicable to the single sport for which the game was designed. Once again, the application program's logic, presentation, and data structures are combined into a package that is generally marketed and sold as a unique product.

In some instances, a sports application program is designed to work across multiple sports; however, this is accomplished by limiting the design of the program to those sports, or areas of interest within a sport, that do not involve any information that is sport specific in nature. A good example of this type of program is one that tracks an athlete's workouts or training regimen. Though the program may support multiple sports within its single interface and design, it does so by using a lowest common denominator approach. Only generic, non-specific information areas are eligible for inclusion in this type of sports program. For example, a training sports software application might contain a database structure designed to store information about an athlete's workouts including the date, time, exercises performed, repetitions, and other performance factors. Although the program is usable by athletes in multiple sports, its scope is limited to an area of interest that can only include generic data that is non-sport specific.

Although today's sports software application programs are either sport specific in nature or limited in scope in those instances where they provide support for multiple sports, a potential application design could embed the necessary logic, presentation, and data structures within a single program to fully support multiple sports. However, this would prove extremely cumbersome and inefficient due to the inability of this architecture to extend the program's support to sports not included in the original design.

### BRIEF SUMMARY OF THE INVENTION

The disclosed method provides personal computer sports software developers with a software design process to create sports software application programs that function across all sports, eliminating the need to create and maintain separate, sport specific versions of a functionally similar program. By wrapping all sport specific data (e.g., statistics) within an external sport season software data entity that is separate from the main application program, end users are presented with a more flexible and useful software application that enables them to manage sports information for any sport in which they participate. In cases where an athlete participates in multiple sports, or the sports software program is used in a family setting where the children participate in different sports, the cost of purchasing additional versions dedicated to a given sport is removed along with the potential need to learn an additional user interface.

An embodiment of the present invention provides a method and system that enables a personal computer sports software application program, a digital sport scrapbook in this instance, to modify its user interface and functional components to accommodate statistical data specific to any one of a number of different sports. The present invention, known as GameDiary, incorporates modular data entities (i.e., “Seasons”) that contain or reference information pertinent to an athlete's sport season. Seasons contain or reference a data structure that represents a plurality of games or similar season events for a given player or a team of players. Within this data structure, each game or season event contains related information including game scores, statistics, notes, pictures and multimedia. Within this embodiment, a database is created to store this information when a user creates a new Season. Every Season also contains, directly or indirectly, a reference to a profiled player and an associated statistical sport package for that player. This is the defining information that enables the system to function across multiple sports and to do so for different players. Within this embodiment of the present invention, the statistical sport package is an independent software data entity comprised of information describing each statistic, and embedded logic that defines any calculated statistics included within the package.

Under control of its parent sports software application program, Season's are created, stored, and loaded as required. When a user selects the menu option to create a new Season, the program dynamically generates an internal list of available sport packages. This list is created based on the external sport statistical packages that reside within the program's data directories. Upon creating a new Season or loading an existing one, the program loads the appropriate sport package for the profiled player, and modifies the application program's interface to accommodate the player's sport specific statistical data. As this process effectively decouples the program's user interface and program logic from its data, and does so in the organizational context most appropriate to the area of sports (i.e., an athlete's sport season), the program is able to function across all sports. This process also enables the sports software application's user to create multiple seasons within any sport and to do so for any player.

A companion program, known as GDStats, is also provided in the system to enable an end-user to create, modify and store statistical sport packages. This facility enables the user to customize any sport package to meet their personal needs and requirements.

### BRIEF DESCRIPTION OF THE DRAWINGS

FIG. 1A is a block diagram that illustrates the contents of a Season entity and its relationship to a parent sports software application program.

FIG. 1B is a block diagram similar to FIG. 1A but modified to illustrate an embodiment specific to the disclosed system for managing sports information.

FIG. 2 is a flow diagram of the disclosed method that enables a single sports software application program to modify its user interface and functional components to accommodate and manage information specific to any one of a number of different sports.

FIG. 3 is a flow diagram of a routine to create a new Season.

FIG. 4 is a flow diagram of a routine to open a new Season.

FIG. 5 illustrates the primary user interface of one embodiment of the present invention.

FIG. 6 illustrates the appearance of a statistical sport package for each of three sample sports.

FIG. 7 depicts the screen output of the program that enables a user to create and modify a sport package to meet their personal needs and requirements.

FIG. 8 is a flow diagram of a routine to customize a sport package

### DETAILED DESCRIPTION OF THE INVENTION

Referring to the drawings, wherein like reference numerals denote like parts throughout the various drawing figures, the present disclosure illustrates a method and system that enables a single sports software application, a digital sports scrapbook of an athlete's sports season in this instance, to modify its user interface and functional components to accommodate and otherwise manage information specific to any one of a number of different sports.

This method uses a separate data entity, referred to as a Season, to decouple sport specific data from the main sports software application program and optionally enable the sports application to create and manage different Seasons for different players.

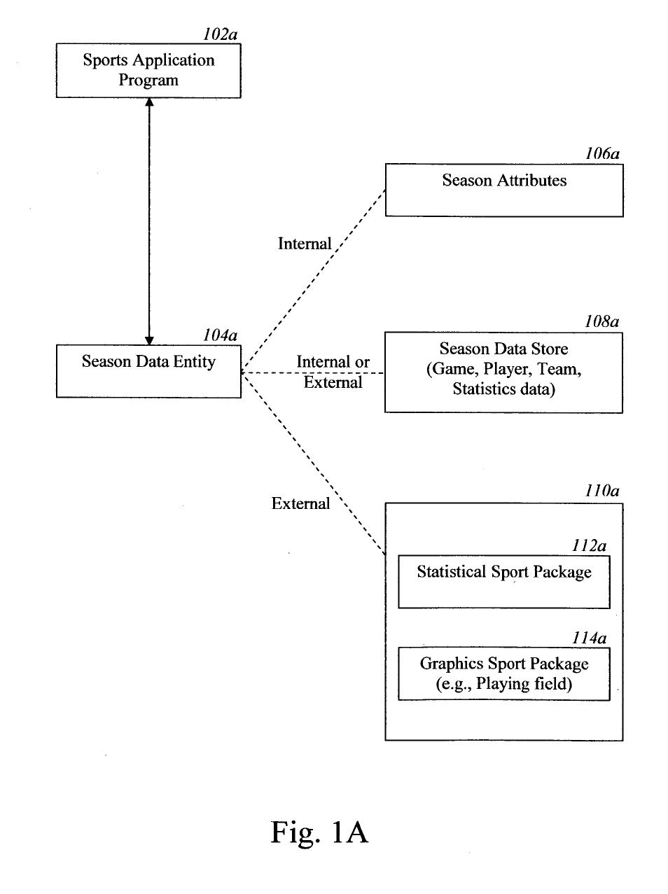

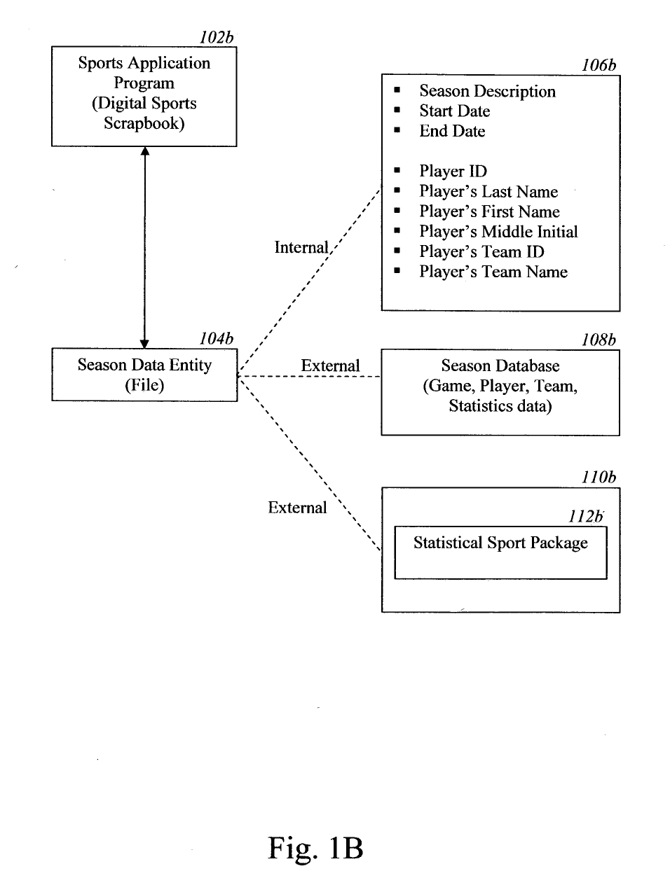

FIG. 1A is a block diagram illustrating the contents of a Season data entity and its relationship to a parent sports software application program. The program 102a interacts with the Season data entity 104a, creating or opening the Season as specified by the user. The Season contains internal information 106a that generally describes the sports season and optionally a player or team for which the Season data applies. The Season also references a data store 108a that contains data pertinent to the games or other events that comprise a Season. Finally, the Season references an external sport package 110a. Two primary types of sport packages are shown: a Statistical Sport Package 112a and a Sports Graphics Package 114a. The Statistical Sport Package is a file that contains information describing a plurality of statistics specific to a single sport, where the defined properties for each statistic include a name, value container, and if calculated, a formula or script that references other statistics contained in the same sport package. Note that although a statistical sport package can accept an actual value, statistical values are maintained in the data store associated with the Season. The Graphics Sport Package contains graphical objects such as a sports playing field that are sport specific. These graphical objects may also include internal information and logic that defines their appearance and behavior within the parent sports application program.

FIG. 1B is a block diagram similar to FIG. 1A but modified to illustrate an embodiment specific to the disclosed system for managing sports information. The parent sports software application program 102b, a digital sports scrapbook in this instance, interacts with the Season data entity 104b, creating or opening the Season as specified by the user. The Season contains internal information 106b that describes the sports season and profiled player. Information describing the player's season includes a Description, Start Date, and End Date. Information describing the player for whom the season information applies includes a Player ID number, Player's Last Name, Player's First Name, Player's Middle Initial, Player's Team ID number, and Player's Team Name. The Season also references an external database of game data (e.g., Game, Player, Team, and Statistics information) 108b and an external sport package 110b. The Statistical Sport Package 112b is a file that contains information describing a plurality of statistics specific to a single sport, where the defined properties for each statistic include a name, value container, and if calculated, a formula or script that references other statistics contained in the same sport package. Again, although a statistical sport package can accept an actual value, statistical values are maintained in the database associated with the Season.

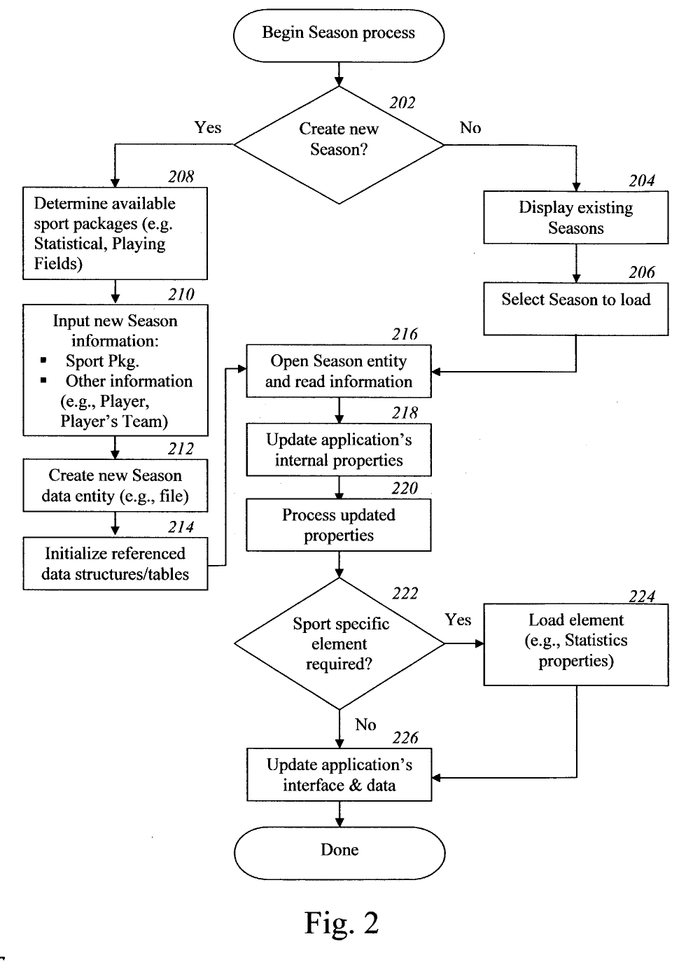

FIG. 2 is a flow diagram that provides an overview of the method for using a Season within a sports application program. In step 202, the process begins with the sports application's user selecting, via the program's menu, to either create a new Season or display and select an existing Season to load. When the user chooses to open an existing Season, the program examines a directory in which Season files are located and displays a list of existing Seasons 204 via an input form. In step 206, the user selects the desired Season. Looking at the portion of the method applicable to creating a new Season, the program first determines what sport packages are available in step 208. The program examines a central file directory used to store standard Sport Packages and the Season's file directory and then generates a list of available sport packages. An input form is displayed in step 210 in which the user selects a sport package from a displayed list of available packages, and provides other season related information such as the profiled player's name and team name. In step 212, the program creates a new Season file that contains the information provided in step 210. In step 214, the program creates and initializes any of its standard data structures (e.g. database tables) that are associated with the new Season. This data may be maintained directly within the Season file or in an external location or database that is referenced from within the Season file. In step 216, a newly created Season or an existing one selected by the application's user is opened and its data accessed. In step 218, the program then updates its internal properties to reflect the information contained within the Season file. In step 220, the program processes these properties accordingly. This step may include updating screen information to reflect such elements as the new season's game data and the name of the player athlete for which the Season applies. In steps 222 through 226, the program processes any sport specific elements (e.g., statistic properties contained in the associated sport package) and accordingly updates its associated internal properties and user interface. Note that the updated internal properties representing statistical information are not only accessed by user interface elements, but can also be used within output reports (e.g., headings for a season statistics summary report).

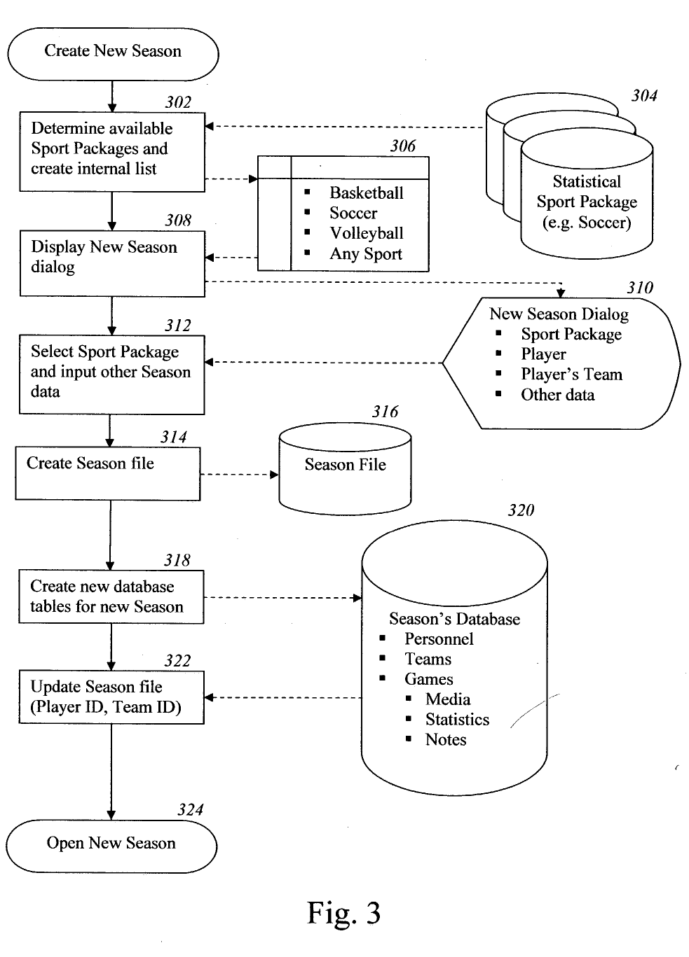

FIG. 3 is a flow diagram of a routine to create a new Season as implemented in one embodiment of the present invention. In step 302, the generic sports software application program generates an internal list of the sports 306 supported by determining which statistical sport package files 304 are located in a directory accessible to the application, parsing the file names, and adding each character string to the list. In step 308, the program displays a New Season dialog box 310 in response to a user request. The dialog box contains input controls in which the user can specify the key attributes of the new Season. This includes the sport package (selected from the internally generated list 306), Player's name, Player's team, Season Description, Season start date, Season end date, and a name for the Season file. In step 314, the program creates the new Season file 316 and adds the information supplied by the user. In step 318, the program creates a new directory in which to store the database tables, creates the appropriate tables, and initializes them accordingly. In step 322, the program updates the Season file to include information generated from the database initialization (e.g., Player and Team identification numbers) and also includes a reference to the sport package file's location. In step 324, the program then opens the new Season as it would an existing Season—a process described below.

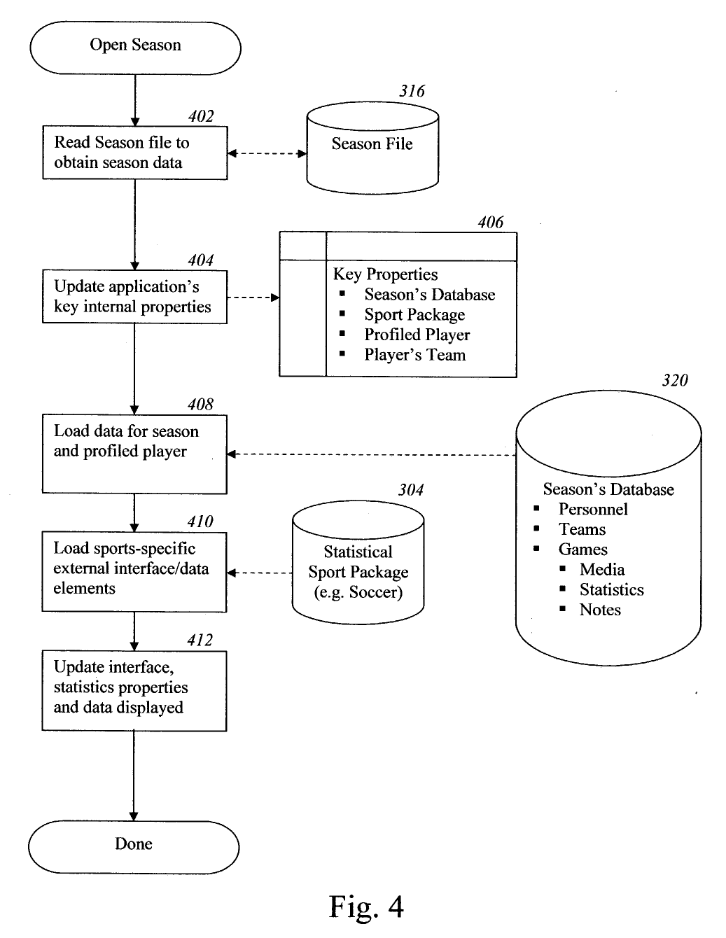

FIG. 4 is a flow diagram of a routine to open a Season as implemented in one embodiment of the present invention. This routine is accessed within the generic sports software application program when the user displays the appropriate open season dialog and selects an existing Season. It is also accessed automatically by the program subsequent to creating a new Season as shown in FIG. 3 and described above. In step 402, the program reads the information contained in the selected Season file 316 and then updates the program's associated internal properties 406 per step 404. In step 408, the program loads data from the Season's database 320. In step 410, the program accesses and loads the Statistical Sport Package 304 referenced by the Season. Finally, in step 412, the program updates its properties and user interface to reflect the information contained in the Season file, Season database, and Statistical Sport Package.

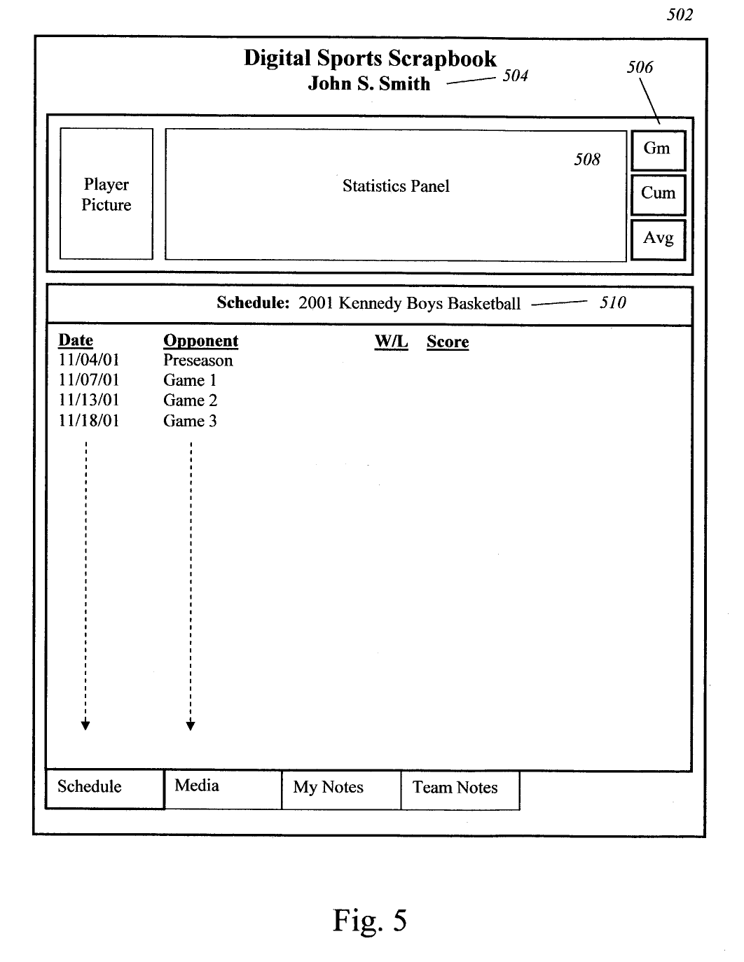

FIG. 5 illustrates the primary user interface of one embodiment of the present invention. The main screen of the sports application 502 contains the player athlete's name 504 and the Season description 510. When a Season is opened, the displayed data is updated to reflect this information. An area of the application program's user interface display 508, referred to as the Statistics Panel, is dedicated to the statistics information that is loaded from the Statistical Sport Package associated with the active Season. The statistics panel is a software object that contains statistic labels and value fields, along with associated properties similar to those contained within the sport package. When a sport package is loaded, the statistic panel's item properties are updated to reflect the respective property values contained within the loaded sport package. The three buttons, referenced by 506, represent individual game, cumulative, and average per game views of the statistical information. When the application's user clicks on one of the three buttons, the program invokes the respective internal calculation method associated with the selected view. The program then accesses the statistical values maintained in the active Season's database, performs any necessary calculations based on the formula or script, and updates its display. Note that the design of a process for implementing a sport package's loading and interaction with the parent sports application may vary within different embodiments; however, the key design aspect of this system is that the statistic's visual appearance and calculation logic remain independent of the parent sports application program.

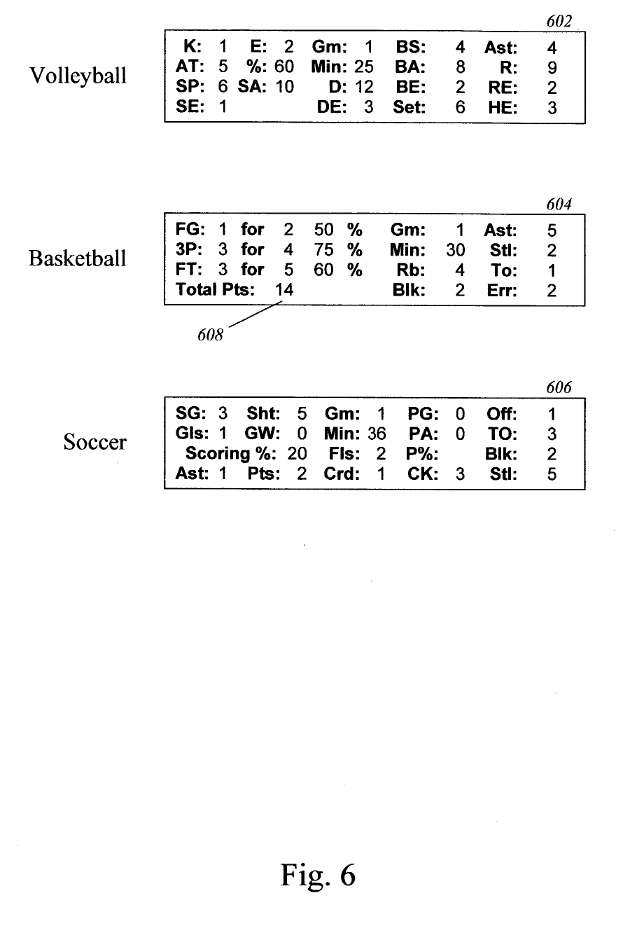

FIG. 6 illustrates the appearance of a statistical sport package for each of three sample sports. Specifically, a Volleyball panel 602, Basketball panel 604, and Soccer panel 606 are included. Each panel displays different statistics—ones that are appropriate for the sport referenced by their associated Season. The panel includes user input fields for non-calculated statistics and the internal logic to calculate summary statistics (e.g. Total Points 608). In addition to the nature of the statistics included within a panel, other examples of sport specific information and functionality contained within a Statistical Sport Package include Hint descriptions for each statistic, input validation appropriate to each statistic requiring user input, and the algorithms necessary to generate any calculated statistics.

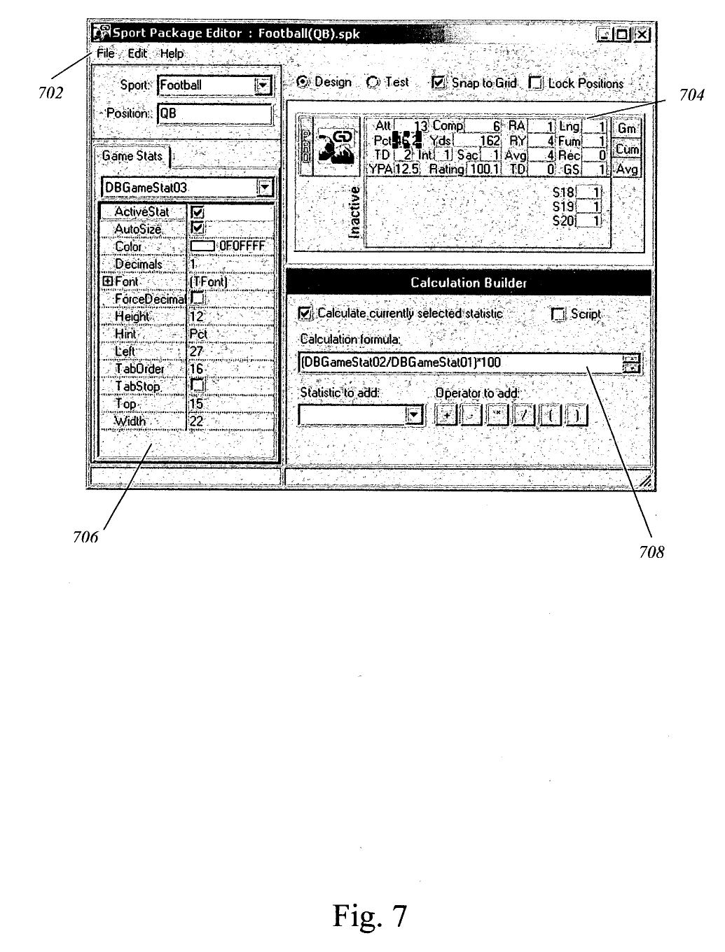

FIG. 7 depicts the screen output of the program that enables a user to create and modify a sport package to meet their personal needs and requirements. The program in one embodiment of the present invention., known as GDStats, includes a menu 702 that enables a user to open, save or create a new sport package. A panel 704 contains a plurality of statistic labels and values, each of which has properties that a user can modify. The user can select a statistic label or value with a pointing device and move or resize the item. Once selected, a label or value's properties are changed by modifying the appropriate property value shown in panel 706. Also, if the selected statistic value represents a calculation, a checkbox is selected and a formula or script entered in the calculation formula edit area 708.

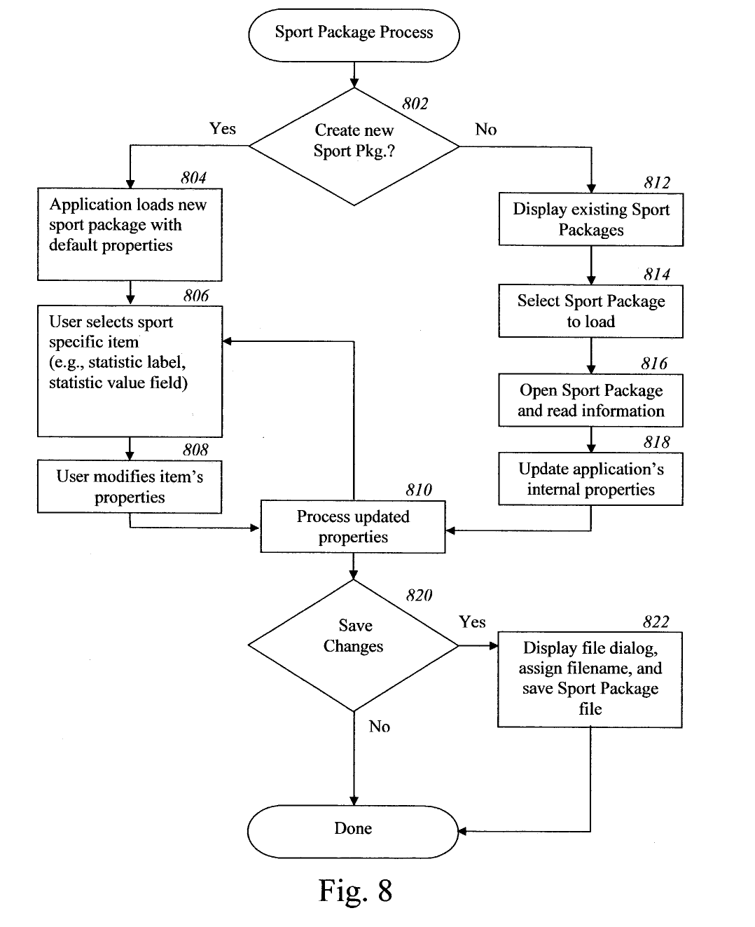

FIG. 8 is a flow diagram of a method to customize a sport package within the preferred embodiment of the current invention as depicted in FIG. 7. A sport package is first created 802 by loading a new sport package that contains an initial default set of statistics and values 804. A user of this method then selects a statistic label or field 806 and subsequently modifies the item's properties using a property inspector facility contained within the program. The item's location and size can also be modified by using a pointing device. The process updates any internal properties while, if necessary, also updates the item's visual appearance 810. Steps 806 and 808 are repeated as necessary for each statistic label and value. To open an existing sport package, rather than creating a new sport package, a dialog box displays a list of available sport package 812. This list is generated by locating existing sport packages in standard file directories used by the parent sports software application. The sport package is selected 814, its information read 816, and internal properties updated 818. These properties include ones for each statistic label and value item. The process then updates the visual appearance for each of the statistic items included in the sport package 810. At this point, a user of this process can then modify individual statistic items 806, 808. Once the statistic panel meets the requirements of the user, changes can be saved using a dialog box designed for this purpose 822.

The preferred embodiment of the system described in the present invention was developed using Borland's Delphi programming environment and is compatible with the Microsoft Windows operating system. A single CD-ROM accompanies these specifications and includes the object code for both GameDiary and the GDStats applications. The system is fully operational and can be installed on a compatible personal computer using the included CD-ROM.

Although the present invention has been described in terms of a preferred embodiment, it is not intended that the invention be limited to this embodiment. Modification within the spirit of the invention will be apparent to those skilled in the art. For example, a Season could contain all of its information directly in a single data entity as opposed to referencing an external database and sport package as described in the present invention. The information contained within the Season file itself could also be implemented as a top-level database table within a database created to represent all information pertinent to a sports season. The nature of the sport packages may also vary in theme and provide greater capability then those described herein. The method of using sport packages within the context of a Season to support multiple sports and provide greater extensibility to the parent application would still apply to these embodiments. The design of a user interface for a sports software application program, such as the one described herein, could also vary significantly but still depend on the mechanism of loading independent Season data entities to provide the application with sport specific features and capability of the present invention. Accordingly, modifications such as those suggested above, but not limited thereto, are to be considered within the scope of the instant invention as set forth above and as described by the claims that follow.

I claim:

1. A computer method for managing sports information comprising:
under control of a personal computer sports software application program,
using modular sport season data entities that contain, reference, or otherwise encapsulate information pertinent to an athlete, coach, or team's sport season,
creating, storing, loading and deleting said sport season data entities upon a user's request,
customizing said program's internal properties, user interface, and data displayed based on information contained within the said sport season data entity,
customizing said program's internal properties, user interface, and data displayed based on information referenced from within the said sport season data entity,
whereby said program can store, display, organize, analyze, output and otherwise manage information specific to any one of a number of different sports, and
whereby said method enables software developers to improve their efficiency by eliminating the need to create and maintain separate, sport specific versions of a functionally similar application program while also providing users of said program with a substantially more flexible and useful product.

2. The sports software application program of claim 1, wherein said program's underlying design architecture is generic in nature, substantially independent of any information contained within said program that is specific to a single sport or group of sports.

3. The method of claim 1, wherein said method's design goal includes managing player statistics for multiple sports.

4. The method of claim 1, wherein season information contained or referenced by said sport season data entity includes scheduled games, player statistics, game notes, pictures, multimedia, and team data.

5. The method of claim 1, further including independent software sport packages that contain properties, data or other information that is substantially specific to a single sport.

6. The method of claim 5, wherein said method includes means to load said sport packages and modify said program's internal properties and user interface according to said sport packages properties and data.

7. The method of claim 5, wherein said method includes means for said user to associate said sport package with said sport season data entity when the user creates or modifies the season data entity.

8. The method of claim 5, wherein said method includes means to create, modify, and store said software sport packages.

9. The method of claim 5, wherein the said sport packages describe a plurality of statistics specific to a single sport wherein the defined properties for each statistic include a name, value, and if calculated, a formula that references other statistics contained in the same software sport package.

10. The method of claim 5, wherein the said sport packages contain graphical elements and associated properties and data that define said element's appearance and behavior within the said sports software application program.

11. A system for managing sports information comprising:
a personal computer sports software application program,
modular sport season data entities that contain, reference, or otherwise encapsulate information pertinent to an athlete's sport season,
means to create, open, delete and otherwise manage said sport season data entities,
means to customize said program's internal properties, user interface, and displayed data based on information contained within said sports season data entities,
means to customize said program's internal properties, user interface, and displayed data based on information referenced from within said sports season data entities,
whereby said program can store, display, organize, analyze, output and otherwise manage information specific to any one of a number of different sports, and
whereby said system enables software developers to improve their efficiency by eliminating the need to create and maintain separate, sport specific versions of a functionally similar application program while also providing users of said program with a substantially more flexible and useful product.

12. The sports software application program of claim 11, wherein said program's underlying design architecture is generic in nature, substantially independent of any information contained within said program that is specific to a single sport or group of sports.

13. The system of claim 11, wherein said system's design goal includes managing player statistics for multiple sports.

14. The system of claim 11, wherein season information contained or referenced by said sport season data entity includes scheduled games, player statistics, game notes, pictures, multimedia, and team data.

15. The system of claim 11, further including independent software sport packages that contain properties, data or other information that is substantially specific to a single sport.

16. The system of claim 15, wherein said system includes means to load said sport packages and modify said program's internal properties and user interface according to said sport packages properties and data.

17. The system of claim 15, wherein said system includes means for said user to associate said sport package with said sport season data entity when the user creates or modifies the season data entity.

18. The system of claim 15, wherein said method includes a program to create, modify, and store said software sport packages.

19. The system of claim 15, wherein the said sport packages describe a plurality of statistics specific to a single sport wherein the defined properties for each statistic include a name, value, and if calculated, a formula that references other statistics contained in the same software sport package.
